(19) United States
(12) Patent Application Publication
(10) Pub. No.: US 2026/0336560 A1
(43) Pub. Date: Oct. 29, 2026

(54) Control System, Method, and Apparatus

(71) Applicant: Yinwang Intelligent Technologies Co., Ltd., Shenzhen (CN)

(72) Inventors: Wei Li, Shanghai (CN); Puhao Wang, Shanghai (CN); Xinming Ge, Shanghai (CN); Liang Jia, Shanghai (CN); Liyong Liu, Shenzhen (CN); Jiongmin Guo, Shanghai (CN)

(73) Assignee: Yinwang Intelligent Technologies Co., Ltd., Shenzhen (CN)

(21) Appl. No.: 19/703,782

(22) Filed: Jun. 10, 2026

Related U.S. Application Data
(63) Continuation of application No. PCT/CN2024/137707, filed on Dec. 9, 2024.

(30) Foreign Application Priority Data
Dec. 11, 2023 (CN) 202311702732.0

(51) Int. Cl. B60R 25/01; B60R 21/013

(52) U.S. Cl. CPC B60R 25/012; B60R 21/013

(57) ABSTRACT

A control system includes a first control unit and a second control unit. The first control unit is configured to control a first vehicle door to be unlocked, and the second control unit is configured to control a second vehicle door to be unlocked. The first control unit is further configured to establish a communication connection to the second control unit, obtain a collision signal, control the first vehicle door to be unlocked based on the collision signal, and send a first unlocking instruction to the second control unit. The first unlocking instruction is used to instruct to unlock the second vehicle door. According to the system, all vehicle doors of a vehicle are not controlled by one control unit to be unlocked.

### CROSS-REFERENCE TO RELATED APPLICATIONS

This is a continuation of International Patent Application No. PCT/CN2024/137707 filed on Dec. 9, 2024, which claims priority to Chinese Patent Application No. 202311702732.0 filed on Dec. 11, 2023. The disclosures of the aforementioned applications are hereby incorporated by reference in their entireties.

### TECHNICAL FIELD

The present disclosure relates to the field of intelligent vehicles, and more specifically, to a control system, method, and apparatus.

### BACKGROUND

After a vehicle collision, electrical lines inside a vehicle may be exposed due to collision compression or sheet metal cutting, which may further cause a short circuit and fire. In particular, for a new energy vehicle, a power battery is more likely to burn after being compressed. Therefore, after the vehicle collision, it is necessary to ensure that people inside the vehicle can quickly leave the vehicle. In this case, whether a vehicle door can be successfully unlocked becomes particularly important. Currently, after the vehicle collision, an airbag module (ABM) may send a collision signal to a body control module (BCM), and the BCM drives a door lock motor of the vehicle door to complete unlocking.

However, when an execution link (for example, an ABM-to-BCM communication link) fails or the BCM is damaged, the vehicle door cannot be successfully unlocked, thereby threatening personal safety of the people inside the vehicle.

### SUMMARY

The present disclosure provides a control system, method, and apparatus, to ensure that a vehicle door is unlocked in time in a vehicle collision, thereby ensuring personal safety of people inside a vehicle.

According to a first aspect, a control system is provided. The system includes a first control unit and a second control unit, where the first control unit establishes a communication connection to the second control unit, the first control unit is configured to control a first vehicle door to be unlocked, and the second control unit is configured to control a second vehicle door to be unlocked; the first control unit is configured to obtain a collision signal; and the first control unit is further configured to: control, based on the collision signal, the first vehicle door to be unlocked, and send a first unlocking instruction to the second control unit, where the first unlocking instruction is used to instruct to unlock the second vehicle door.

In some possible implementations, the first control unit and the second control unit each may be in a form of a chip, a processor, or a controller. Further, the first control unit and the second control unit may be vehicle integration units (VIU).

In some possible implementations, the first vehicle door and the second vehicle door may be vehicle doors corresponding to different positions of a vehicle. For example, the first vehicle door is a vehicle door corresponding to a driver position, and the second vehicle door is a vehicle door corresponding to a front passenger position. For another example, the first vehicle door is a vehicle door corresponding to the driver position, and the second vehicle door is a vehicle door corresponding to a rear right position.

In this embodiment of the present disclosure, the first control unit may unlock the first vehicle door based on the collision signal, and send the first unlocking instruction to the second control unit, so that the second control unit unlocks the second vehicle door based on the first unlocking instruction. In this way, all vehicle doors of a vehicle are not controlled by one control unit to be unlocked. In addition, even if the second control unit cannot obtain the collision signal due to a fault or a damaged communication link, the second control unit can successfully unlock the second vehicle door based on the first unlocking instruction. In this way, it can be ensured that at least one vehicle door is successfully unlocked in a vehicle collision, thereby ensuring personal safety of people inside the vehicle.

With reference to the first aspect, in some implementations of the first aspect, the system further includes a third control unit; the first control unit is further configured to obtain a second unlocking instruction sent by the third control unit, where the second unlocking instruction is used to instruct to unlock the first vehicle door; and the first control unit is specifically configured to control, based on the collision signal and the second unlocking instruction, the first vehicle door to be unlocked.

In some possible implementations, the third control unit and the second control unit may be a same control unit, or may be different control units.

In some possible implementations, the second unlocking instruction may be generated by the third control unit, or may be generated by another control unit and then sent to the third control unit.

In some possible implementations, after obtaining the collision signal and the second unlocking instruction, the first control unit may control the first vehicle door to be unlocked once, or after obtaining the collision signal, the first control unit may control the first vehicle door to be unlocked once, and then control the first vehicle door to be unlocked once after receiving the second unlocking instruction.

In this embodiment of the present disclosure, the first control unit may control the first vehicle door to be unlocked based on the second unlocking instruction and the collision signal. In this way, when the first control unit controls the first vehicle door to be unlocked once after obtaining the collision signal and the second unlocking instruction, a case in which the first vehicle door is mistakenly unlocked can be reduced. In addition, when the first control unit controls the first vehicle door to be unlocked once after obtaining the collision signal, and then controls the first vehicle door to be unlocked once after receiving the second unlocking instruction, reliability of unlocking the first vehicle door can be improved, thereby further ensuring personal safety of the people inside the vehicle.

With reference to the first aspect, in some implementations of the first aspect, the system further includes a third control unit and a fourth control unit; the fourth control unit is configured to obtain the collision signal; the fourth control unit is further configured to generate a third unlocking instruction based on the collision signal, where the third unlocking instruction is used to instruct to unlock the first vehicle door; the fourth control unit is further configured to send the third unlocking instruction to the third control unit; the third control unit is further configured to send the third unlocking instruction to the first control unit; and the first control unit is specifically configured to unlock the first vehicle door based on the collision signal and the third unlocking instruction.

In some possible implementations, the third unlocking instruction and the second unlocking instruction may be a same unlocking instruction, or may be different unlocking instructions.

In some possible implementations, after obtaining the collision signal and the third unlocking instruction, the first control unit may control the first vehicle door to be unlocked once, or after obtaining the collision signal, the first control unit may control the first vehicle door to be unlocked once, and then control the first vehicle door to be unlocked once after receiving the third unlocking instruction.

In this embodiment of the present disclosure, after obtaining the collision signal, the fourth control unit may first send the third unlocking instruction to the third control unit, and then the third control unit forwards the third unlocking instruction to the first control unit. The first control unit may unlock the first vehicle door based on the collision signal and the third unlocking instruction. In this way, even if the third control unit cannot obtain the collision signal due to a fault or a damaged communication link, the third control unit may forward the third unlocking instruction to the first control unit, thereby ensuring that the first vehicle door is successfully unlocked.

With reference to the first aspect, in some implementations of the first aspect, the system further includes a fifth control unit; and the first control unit is further configured to control the first vehicle door to be unlocked when no fourth unlocking instruction from a fifth control unit is received within preset duration since the collision signal is obtained, where the fourth unlocking instruction is used to instruct to unlock the first vehicle door.

In some possible implementations, the fifth control unit and the second control unit may be a same control unit, or may be different control units.

In this embodiment of the present disclosure, if the first control unit does not receive the fourth unlocking instruction within the preset duration since the collision signal is obtained, the first control unit may directly control the first vehicle door to be unlocked. In this way, while reducing a case in which the first vehicle door is mistakenly unlocked, reliability of unlocking the first vehicle door can be further improved.

With reference to the first aspect, in some implementations of the first aspect, the first control unit is further configured to control, based on the collision signal, a door handle corresponding to the first vehicle door to pop out.

In this embodiment of the present disclosure, for a vehicle disposed with a hidden door handle, the first control unit may further control, based on the collision signal, the door handle corresponding to the first vehicle door to pop out. In this way, when an accident occurs on the vehicle, rescue personnel can perform rescue operations.

With reference to the first aspect, in some implementations of the first aspect, the second control unit is configured to control, based on the first unlocking instruction, the second vehicle door to be unlocked.

With reference to the first aspect, in some implementations of the first aspect, the second control unit is further configured to obtain the collision signal; and the second control unit is specifically configured to control, based on the collision signal and the first unlocking instruction, the second vehicle door to be unlocked.

With reference to the first aspect, in some implementations of the first aspect, the first unlocking instruction is further used to instruct to pop out a door handle corresponding to the second vehicle door; and the second control unit is further configured to control, based on the first unlocking instruction, the door handle corresponding to the second vehicle door to pop out.

In this embodiment of the present disclosure, for a vehicle disposed with a hidden door handle, the second control unit may control, based on the first unlocking instruction, the door handle corresponding to the second vehicle door to pop out. In this way, when an accident occurs on the vehicle, rescue personnel can perform rescue operations.

According to a second aspect, a control method is provided. The method is applied to a first control unit. The first control unit is configured to control the first vehicle door to be unlocked. The method includes: obtaining a collision signal; and controlling, based on the collision signal, the first vehicle door to be unlocked, and sending a first unlocking instruction to a second control unit, where the first unlocking instruction is used to instruct to unlock a second vehicle door corresponding to the second control unit.

In this embodiment of the present disclosure, the first control unit may unlock the first vehicle door based on the collision signal, and send the first unlocking instruction to the second control unit, so that the second control unit unlocks the second vehicle door based on the first unlocking instruction. In this way, all vehicle doors of a vehicle are not controlled by one control unit to be unlocked. In addition, even if the second control unit cannot obtain the collision signal due to a fault or a damaged communication link, the second control unit can successfully unlock the second vehicle door based on the first unlocking instruction. In this way, it can be ensured that at least one vehicle door is successfully unlocked in a vehicle collision, thereby ensuring personal safety of people inside the vehicle.

With reference to the second aspect, in some implementations of the second aspect, the method further includes: obtaining a second unlocking instruction from a third control unit, where the second unlocking instruction is used to instruct to unlock the first vehicle door; and controlling, based on the collision signal, the first vehicle door to be unlocked includes: controlling, based on the collision signal and the second unlocking instruction, the first vehicle door to be unlocked.

In this embodiment of the present disclosure, the first control unit may control the first vehicle door to be unlocked based on the second unlocking instruction and the collision signal. In this way, when the first control unit controls the first vehicle door to be unlocked once after obtaining the collision signal and the second unlocking instruction, a case in which the first vehicle door is mistakenly unlocked can be reduced. In addition, when the first control unit controls the first vehicle door to be unlocked once after obtaining the collision signal, and then controls the first vehicle door to be unlocked once after receiving the second unlocking instruction, reliability of unlocking the first vehicle door can be improved, thereby further ensuring personal safety of the people inside the vehicle.

With reference to the second aspect, in some implementations of the second aspect, controlling, based on the collision signal, the first vehicle door to be unlocked includes: controlling the first vehicle door to be unlocked when no fourth unlocking instruction from a fifth control unit is received within preset duration since the collision signal is obtained, where the fourth unlocking instruction is used to instruct to unlock the first vehicle door.

In this embodiment of the present disclosure, if the first control unit does not receive the fourth unlocking instruction within the preset duration since the collision signal is obtained, the first control unit may directly control the first vehicle door to be unlocked. In this way, while reducing a case in which the first vehicle door is mistakenly unlocked, reliability of unlocking the first vehicle door can be further improved.

With reference to the second aspect, in some implementations of the second aspect, the method further includes: controlling, based on the collision signal, a door handle corresponding to the first vehicle door to pop out.

In this embodiment of the present disclosure, for a vehicle disposed with a hidden door handle, the first control unit may further control, based on the collision signal, the door handle corresponding to the first vehicle door to pop out. In this way, when an accident occurs on the vehicle, rescue personnel can perform rescue operations.

With reference to the second aspect, in some implementations of the second aspect, the first unlocking instruction is further used to instruct to pop out a door handle corresponding to the second vehicle door.

In this embodiment of the present disclosure, when the first unlocking instruction sent by the first control unit is further used to instruct to pop out the door handle corresponding to the second vehicle door, after receiving the first unlocking instruction, the second control unit may further pop out the door handle corresponding to the second vehicle door. In this way, when the accident occurs on the vehicle, the rescue personnel can perform the rescue operations.

According to a third aspect, a control apparatus is provided. The apparatus is configured to control a first vehicle door to be unlocked. The apparatus includes an obtaining unit and a processing unit; the obtaining unit is configured to obtain a collision signal; and the processing unit is configured to: control, based on the collision signal, the first vehicle door to be unlocked, and send a first unlocking instruction to a second control unit, where the first unlocking instruction is used to instruct to unlock a second vehicle door corresponding to the second control unit.

With reference to the third aspect, in some implementations of the third aspect, the obtaining unit is further configured to obtain a second unlocking instruction from a third control unit, where the second unlocking instruction is used to instruct to unlock the first vehicle door; and the processing unit is specifically configured to control, based on the collision signal and the second unlocking instruction, the first vehicle door to be unlocked.

With reference to the third aspect, in some implementations of the third aspect, the processing unit is specifically configured to control the first vehicle door to be unlocked when no fourth unlocking instruction from a fifth control unit is received within preset duration since the collision signal is obtained, where the fourth unlocking instruction is used to instruct to unlock the first vehicle door.

With reference to the third aspect, in some implementations of the third aspect, the processing unit is further configured to control, based on the collision signal, a door handle corresponding to the first vehicle door to pop out.

With reference to the third aspect, in some implementations of the third aspect, the first unlocking instruction is further used to instruct to pop out a door handle corresponding to the second vehicle door.

According to a fourth aspect, a control apparatus is provided, including at least one processor and a memory. The at least one processor is coupled to the memory, and is configured to read and execute instructions in the memory, so that the apparatus implements the method in any implementation of the second aspect.

According to a fifth aspect, a computer-readable storage medium is provided. The computer-readable storage medium stores program code. When the computer program code is run on a computer, the computer is enabled to perform the method in any implementation of the second aspect.

According to a sixth aspect, a chip is provided. The chip includes a circuit, and the circuit is configured to perform the method in any implementation of the second aspect.

According to a seventh aspect, a computer program product is provided. The computer product includes a computer program. When the computer program is run, a computer is enabled to perform the method in any implementation of the second aspect.

According to an eighth aspect, a vehicle is provided, including the control apparatus in any implementation of the third aspect.

### BRIEF DESCRIPTION OF DRAWINGS

FIG. 1 is a functional diagram of a vehicle according to an embodiment of the present disclosure;

FIG. 2 is an unlocking solution according to an embodiment of the present disclosure;

FIG. 3 is a system architecture to which a control method is applicable according to an embodiment of the present disclosure;

FIG. 4 is another system architecture to which a control method is applicable according to an embodiment of the present disclosure;

FIG. 5 is another system architecture to which a control method is applicable according to an embodiment of the present disclosure;

FIG. 6 is a control method according to an embodiment of the present disclosure;

FIG. 7 is another control method according to an embodiment of the present disclosure;

FIG. 8A and FIG. 8B are another control method according to an embodiment of the present disclosure;

FIG. 9 is another control method according to an embodiment of the present disclosure;

FIG. 10 is another control method according to an embodiment of the present disclosure;

FIG. 11 is a control apparatus according to an embodiment of the present disclosure; and

FIG. 12 is another control apparatus according to an embodiment of the present disclosure.

### DESCRIPTION OF EMBODIMENTS

The following describes technical solutions of the present disclosure with reference to accompanying drawings.

In descriptions of embodiments of the present disclosure, “/” means “or” unless otherwise specified. For example, A/B may indicate A or B. In this specification, “and/or” merely describes an association relationship between associated objects and indicates that three relationships may exist. For example, A and/or B may indicate the following three cases: Only A exists, both A and B exist, and only B exists. In the present disclosure, at least one means one or more, and a plurality of means two or more. “At least one of the following items (pieces)” or a similar expression thereof indicates any combination of these items, including a single item (piece) or any combination of a plurality of items (pieces). For example, at least one item (piece) of a, b, or c may indicate: a, b, c, a and b, a and c, b and c, or a, b, and c, where a, b, and c may be singular or plural.

Prefix words “first”, “second”, and the like in embodiments of the present disclosure are merely intended to distinguish between different objects, and impose no limitation on locations, sequences, priorities, quantities, content, or the like of the described objects. Use of prefixes such as ordinal numbers used to distinguish the described objects in embodiments of the present disclosure does not constitute a limitation on the described objects. For descriptions of the described objects, refer to the context description in claims or embodiments, and the use of such prefixes should not constitute a redundant limitation.

The following describes technical solutions of embodiments in the present disclosure with reference to accompanying drawings.

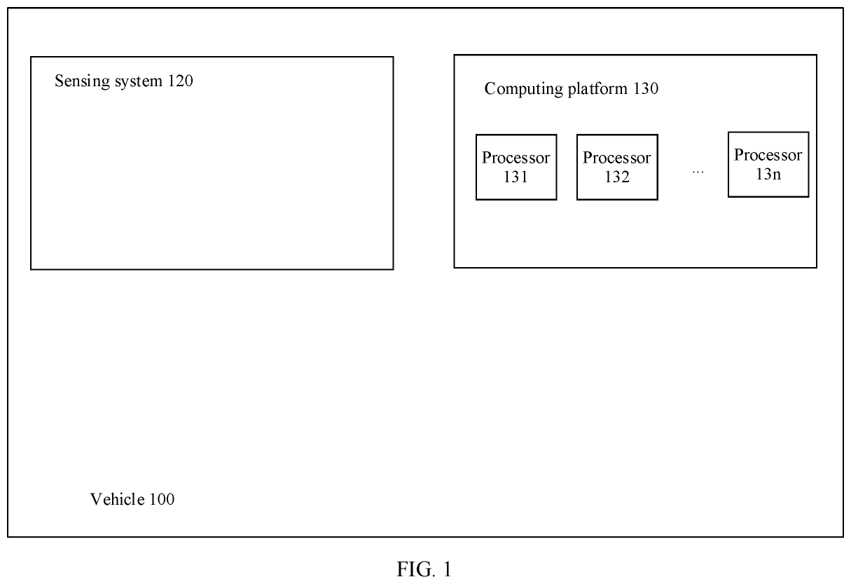

FIG. 1 is a functional diagram of a vehicle 100 according to an embodiment of the present disclosure.

The vehicle 100 may include a plurality of subsystems, for example, a sensing system 120 and a computing platform 130. Optionally, the vehicle 100 may include more or fewer subsystems, and each subsystem may include one or more components. In addition, all the subsystems and components of the vehicle 100 may be interconnected in a wired or wireless manner.

The sensing system 120 may include several types of sensors that are configured to sense information about an environment around the vehicle 100. For example, the sensing system 120 may include a positioning system. The positioning system may be a Global Positioning System (GPS), a BeiDou system, or another positioning system. The sensing system 120 may include one or more of an inertial measurement unit (IMU), a lidar, a millimeter wave radar, an ultrasonic radar, and a camera apparatus.

A part or all of functions of the vehicle 100 may be controlled by the computing platform 130. The computing platform 130 may include processors 131 to 13n (n is a positive integer). The processor is a circuit having a signal processing capability. In an implementation, the processor may be a circuit having an instruction reading and running capability, for example, a central processing unit (CPU), a microprocessor, a graphics processing unit (GPU) (which may be understood as a microprocessor), or a digital signal processor (DSP). In another implementation, the processor may implement a specific function by using a logical relationship of a hardware circuit. The logical relationship of the hardware circuit is fixed or reconfigurable. For example, the processor is a hardware circuit implemented by an application-specific integrated circuit (ASIC) or a programmable logic device (PLD), for example, a field-programmable gate array (FPGA). In the reconfigurable hardware circuit, a process in which the processor loads a configuration document to implement hardware circuit configuration may be understood as a process in which the processor loads instructions to implement functions of a part or all of the foregoing units. In addition, the processor may alternatively be a hardware circuit designed for artificial intelligence, and may be understood as an ASIC, for example, a neural network processing unit (NPU), a tensor processing unit (TPU), or a deep learning processing unit (DPU). In addition, the computing platform 130 may further include a memory. The memory is configured to store instructions. Some or all of the processors 131 to 13n may invoke the instructions in the memory, to implement a corresponding function.

The computing platform 130 may control the functions of the vehicle 100 based on inputs received from the subsystems (for example, the sensing system 120). In some embodiments, the computing platform 130 may be configured to control many aspects of the vehicle 100 and the subsystems of the vehicle.

Optionally, the foregoing components are merely examples. During actual application, the components in the foregoing modules may be added or deleted based on an actual requirement.

The vehicle 100 in the present disclosure may include a road vehicle, a water vehicle, an air vehicle, an industrial device, an agricultural device, an entertainment device, or the like. For example, the vehicle 100 may be a vehicle (for example, a commercial vehicle, a passenger vehicle, a motorcycle, a flight vehicle, or a train), an industrial vehicle (for example, a pallet truck, a trailer, or a tractor), an engineering vehicle (for example, an excavator, a bulldozer, or a crane), an agricultural device (for example, a lawn mower or a harvester), a recreation device, a toy vehicle, and the like. A type of the vehicle is not specifically limited in embodiments of the present disclosure.

The following describes a technical problem to be resolved in the present disclosure and a technical solution used in the present disclosure.

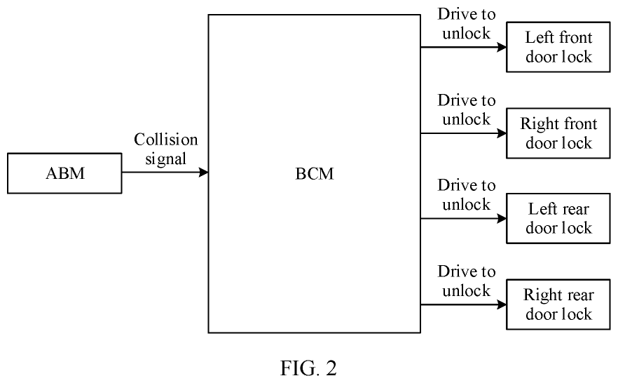

After a vehicle collision, electrical lines inside a vehicle may be exposed due to collision compression or sheet metal cutting, which may further cause a short circuit and fire. In particular, for a new energy vehicle, a power battery is more likely to burn after being compressed. Therefore, after the vehicle collision, it is necessary to ensure that people inside the vehicle can quickly leave the vehicle. In this case, whether a vehicle door can be successfully unlocked becomes particularly important. Currently, as shown in FIG. 2, after the vehicle collision, an ABM may send a collision signal to a BCM, and the BCM drives a door lock motor of the vehicle door to complete unlocking.

However, when an execution link fails, the vehicle door cannot be successfully unlocked, thereby threatening personal safety of people inside the vehicle. For example, when a communication link through which the ABM and the BCM directly communicate with each other is disconnected due to the collision, the collision signal is not transmitted to the BCM. As a result, the BCM cannot complete unlocking during the collision. For another example, when the BCM is damaged due to the collision or a power cable is disconnected, the BCM cannot drive the door lock motor to complete unlocking even if the BCM receives the collision signal. Therefore, any of the foregoing cases may endanger personal safety of the people inside the vehicle.

Embodiments of the present disclosure provide a control system, method, and apparatus, to ensure that a vehicle door is unlocked in time in a vehicle collision, thereby ensuring personal safety of people inside the vehicle.

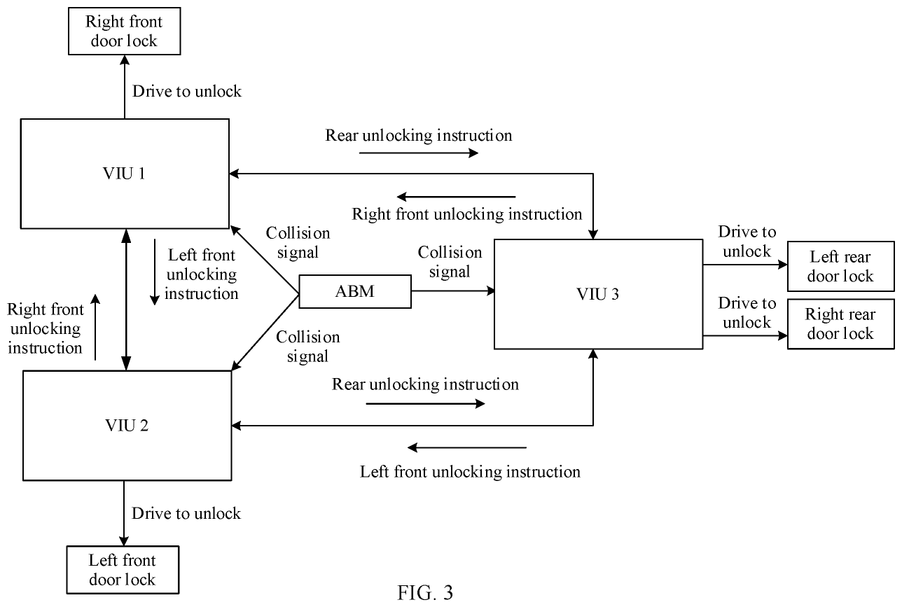

FIG. 3 is a system architecture to which a control method is applicable according to an embodiment of the present disclosure.

As shown in FIG. 3, the architecture includes a VIU 1, a VIU 2, a VIU 3, and an ABM. The VIU 1, the VIU 2, and the VIU 3 may replace a BCM, and may control vehicle door lock motors at different positions. For example, a door lock motor of a right front vehicle door may be driven by the VIU 1, a door lock motor of a left front vehicle door may be driven by the VIU 2, and door lock motors of a left rear vehicle door and a right rear vehicle door may be directly driven by the VIU 3. The VIUs may transmit signals through a network link (for example, a controller area network (CAN) or an ethereum (ETH)) with each other, to form a ring network, thereby implementing bidirectional signal transmission. The ABM may transmit a network signal (for example, a collision signal) to the VIUs, and may further transmit a collision status to the VIUs through a hardwire signal.

This architecture can improve reliability of unlocking during the collision. To be specific, in terms of transmission of the collision signal, the ABM may transmit collision signals to the three VIUs (including the VIU 1, the VIU 2, and the VIU 3) respectively. Even if one or two links between the ABM and the VIUs are damaged due to the collision, the ABM can still transmit the collision signal to at least one VIU through a remaining available link. Then, the VIU that receives the collision signal may transmit the signal to another VIU through the ring network link. In terms of unlocking, different vehicle door motors are connected to different VIUs nearby, and different VIUs can transfer unlocking instructions to each other. When one or two VIUs are damaged due to the collision, successful unlocking of at least one vehicle door can still be ensured, so that a success rate of escape of people inside the vehicle after the vehicle collision can be further improved.

It should be understood that, in the present disclosure, a sensor and an actuator may be connected to a nearby VIU. The VIU serves as a communication interface unit, and may be deployed at a location in which sensors and actuators of vehicles are densely located, so that the sensors and the actuators of the vehicles can be connected to a VIU nearby. In addition, the VIU may have a specific computing and driving capability (for example, the VIU may absorb some driving computing functions of the actuator). The vehicle integration unit and the like in embodiments of the present disclosure may have other names. The VIU and the like are merely examples in the present disclosure, and are not intended to limit specific implementations.

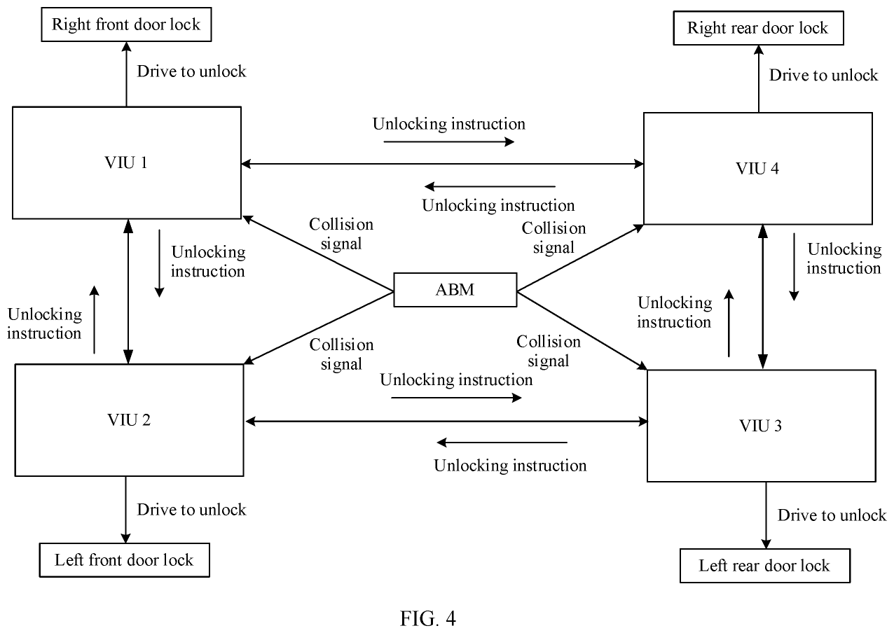

FIG. 4 is another system architecture to which a control method is applicable according to an embodiment of the present disclosure.

As shown in FIG. 4, the architecture includes a VIU 1, a VIU 2, a VIU 3, a VIU 4, and an ABM. The VIU 1, the VIU 2, the VIU 3, and the VIU 4 may replace a BCM, and may control vehicle door locks and door handle motors at different positions. For example, the VIU 1 drives and controls a right front door lock and a right front door handle motor, the VIU 2 drives and controls a left front door lock and a left front door handle motor, the VIU 3 drives and controls a left rear door lock and a left rear door handle motor, and the VIU 4 drives and controls a right rear door lock and a right rear door handle motor. The VIUs may transmit signals through a network link (for example, a CAN or an ETH) with each other, to form a ring network, thereby implementing bidirectional signal transmission. After a collision occurs, the ABM may send collision status signals to the VIU 1, the VIU 2, the VIU 3, and the VIU 4 respectively. After receiving the collision signal, the VIU 1 may control a right front vehicle door to be unlocked and a door handle to pop out, and send an unlocking instruction to another VIU through the ring network. After receiving the collision signal, the VIU 2 may control a left front vehicle door to be unlocked and a door handle to pop out, and send an unlocking instruction to another VIU through the ring network. After receiving the collision signal, the VIU 3 may control a left rear vehicle door to be unlocked and a door handle to pop out, and send an unlocking instruction to another VIU through the ring network. After receiving the collision signal, the VIU 4 may control a right rear vehicle door to be unlocked and a door handle to pop out, and send an unlocking instruction to another VIU through the ring network.

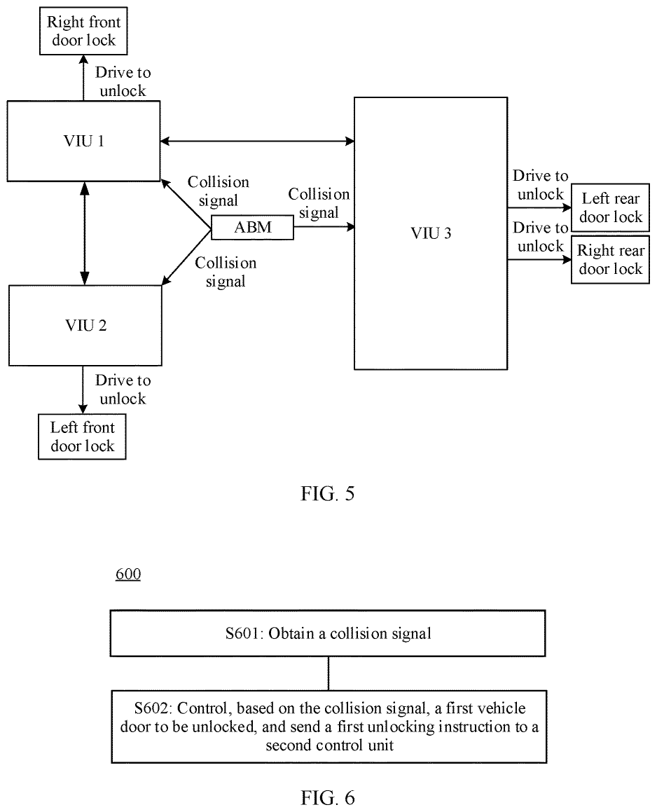

FIG. 5 is another system architecture to which a control method is applicable according to an embodiment of the present disclosure.

As shown in FIG. 5, the architecture includes a VIU 1, a VIU 2, a VIU 3, and an ABM. The VIU 1, the VIU 2, and the VIU 3 may replace a BCM, and may control vehicle door locks and door handle motors at different positions. For example, a door lock motor of a right front vehicle door may be driven by the VIU 1, a door lock motor of a left front vehicle door may be driven by the VIU 2, and door lock motors of a left rear vehicle door and a right rear vehicle door may be directly driven by the VIU 3. Bidirectional signal transmission may be performed between the VIU 1 and the VIU 2 and between the VIU 1 and the VIU 3. After the collision occurs, the ABM may send collision signals to the VIU 1, the VIU 2, and the VIU 3 respectively. After receiving the collision signals, the VIU 1 may control the right front vehicle door to be unlocked and a door handle to pop out, and send the collision signals to the VIU 2 and the VIU 3 through a bidirectional link. After receiving the collision signals, the VIU 2 may control the left front vehicle door to be unlocked of and a door handle to pop out, and send the collision signal to the VIU 1 through the bidirectional link. The VIU 1 forwards the collision signal to the VIU 3. After receiving the collision signals, the VIU 3 may control the left rear vehicle door and the right rear vehicle door to be unlocked and corresponding door handles to pop out, and send the collision signal to the VIU 1 through the bidirectional link. The VIU 1 forwards the collision signal to the VIU 2. In this architecture, because the collision signal between the VIU 2 and the VIU 3 needs to be forwarded by the VIU 1, when the VIU is damaged, or a communication link between the VIU 1 and the VIU 2 is damaged, or a communication link between the VIU 2 and the VIU 3 is damaged, an unlocking instruction may not be transferred between the VIU 2 and the VIU 3.

It should be understood that the architectures shown in FIG. 3 to FIG. 5 are merely examples for description. A person skilled in the art may change the foregoing system architectures based on an actual requirement. For example, when the architectures shown in FIG. 3 to FIG. 5 are designed, a quantity of VIUs may be increased, a manner of transferring the unlocking instruction between the VIUs may be changed, or a correspondence between the VIU and the door lock and the door handle may be changed.

The following describes a control system provided in an embodiment of the present disclosure. The control system may be applicable to the system architecture in any one of FIG. 3 to FIG. 5.

The control system includes a first control unit and a second control unit. The first control unit establishes a communication connection to the second control unit. The first control unit is configured to control a first vehicle door to be unlocked, and the second control unit is configured to control a second vehicle door to be unlocked. The first control unit is configured to obtain a collision signal. The first control unit is further configured to: control the first vehicle door to be unlocked based on the collision signal, and send a first unlocking instruction to the second control unit. The first unlocking instruction is used to instruct to unlock the second vehicle door. Correspondingly, after receiving the first unlocking instruction, the second control unit may control the second vehicle door to be unlocked.

Optionally, the first control unit and the second control unit each may be in a form of a chip, a processor, or a controller. Further optionally, the first control unit and the second control unit may be any two VIUs in any one of the system architectures in FIG. 3 to FIG. 5.

For example, the first control unit may be the VIU 1 in FIG. 3, and the second control unit may be the VIU 2 in FIG. 3. For another example, the first control unit may be the VIU 2 in FIG. 4, and the second control unit may be the VIU 3 in FIG. 4. For still another example, the first control unit may be the VIU 1 in FIG. 5, and the second control unit may be the VIU 3 in FIG. 5.

Optionally, the first vehicle door and the second vehicle door may be vehicle doors corresponding to different positions of a vehicle. For example, the first vehicle door is a vehicle door corresponding to a driver position, and the second vehicle door is a vehicle door corresponding to a front passenger position. For another example, the first vehicle door is a vehicle door corresponding to the driver position, and the second vehicle door is a vehicle door corresponding to a rear right position.

Optionally, when the second control unit can obtain the collision signal, the second control unit may control, based on the collision signal and the first unlocking instruction, the second vehicle door to be unlocked. Further optionally, after obtaining the collision signal and the first unlocking instruction, the second control unit may control the second vehicle door to be unlocked once, or after obtaining the collision signal, the second control unit may control the second vehicle door to be unlocked once, and then control the second vehicle door to be unlocked once after receiving the first unlocking instruction.

In this embodiment of the present disclosure, the first control unit may unlock the first vehicle door based on the collision signal, and send the first unlocking instruction to the second control unit, so that the second control unit unlocks the second vehicle door based on the first unlocking instruction. In this way, all vehicle doors of a vehicle are not controlled by one control unit to be unlocked. In addition, even if the second control unit cannot obtain the collision signal due to a fault or a damaged communication link, the second control unit can successfully unlock the second vehicle door based on the first unlocking instruction. In this way, it can be ensured that at least one vehicle door is successfully unlocked in a vehicle collision, thereby ensuring personal safety of people inside the vehicle.

In an embodiment, the control system further includes a third control unit; the first control unit is further configured to obtain a second unlocking instruction sent by the third control unit, where the second unlocking instruction is used to instruct to unlock the first vehicle door; and the first control unit is specifically configured to control, based on the collision signal and the second unlocking instruction, the first vehicle door to be unlocked.

Optionally, the third control unit and the second control unit may be a same control unit, or may be different control units.

For example, when the first control unit is the VIU 2 in FIG. 5, the second control unit is the VIU 1 in FIG. 5, and the third control unit is the VIU 3 in FIG. 5, the second unlocking instruction may be sent by the VIU 3 to the VIU 2 through the VIU 1.

Optionally, the second unlocking instruction may be generated by the third control unit, or may be generated by another control unit and then sent to the third control unit.

For example, when the first control unit is the VIU 2 in FIG. 5 and the third control unit is the VIU 1 in FIG. 5, the second unlocking instruction may be generated by the VIU 1, or may be generated by the VIU 3 and sent to the VIU 1, and then forwarded by the VIU 1 to the VIU 2.

Optionally, after obtaining the collision signal and the second unlocking instruction, the first control unit may control the first vehicle door to be unlocked once, or after obtaining the collision signal, the first control unit may control the first vehicle door to be unlocked once, and then control the first vehicle door to be unlocked once after receiving the second unlocking instruction.

In this embodiment of the present disclosure, the first control unit may control the first vehicle door to be unlocked based on the second unlocking instruction and the collision signal. In this way, when the first control unit controls the first vehicle door to be unlocked once after obtaining the collision signal and the second unlocking instruction, a case in which the first vehicle door is mistakenly unlocked can be reduced. In addition, when the first control unit controls the first vehicle door to be unlocked once after obtaining the collision signal, and then controls the first vehicle door to be unlocked once after receiving the second unlocking instruction, reliability of unlocking the first vehicle door can be improved, thereby further ensuring personal safety of the people inside the vehicle.

In an embodiment, the control system further includes a third control unit and a fourth control unit; the fourth control unit is configured to obtain the collision signal; the fourth control unit is further configured to generate a third unlocking instruction based on the collision signal, where the third unlocking instruction is used to instruct to unlock the first vehicle door; the fourth control unit is further configured to send the third unlocking instruction to the third control unit; the third control unit is further configured to send the third unlocking instruction to the first control unit; and the first control unit is specifically configured to unlock the first vehicle door based on the collision signal and the third unlocking instruction.

Optionally, the third unlocking instruction and the second unlocking instruction may be a same unlocking instruction, or may be different unlocking instructions.

For example, when the first control unit is the VIU 2 in FIG. 5, the third control unit is the VIU 1 in FIG. 5, and the fourth control unit is the VIU 3 in FIG. 5, the third unlocking instruction is generated by the VIU 3 and sent to the VIU 1, and then forwarded by the VIU 1 to the VIU 2. In other words, the third unlocking instruction and the second unlocking instruction are a same unlocking instruction.

Optionally, after obtaining the collision signal and the third unlocking instruction, the first control unit may control the first vehicle door to be unlocked once, or after obtaining the collision signal, the first control unit may control the first vehicle door to be unlocked once, and then control the first vehicle door to be unlocked once after receiving the third unlocking instruction.

In this embodiment of the present disclosure, after obtaining the collision signal, the fourth control unit may first send the third unlocking instruction to the third control unit, and then the third control unit forwards the third unlocking instruction to the first control unit. The first control unit may unlock the first vehicle door based on the collision signal and the third unlocking instruction. In this way, even if the third control unit cannot obtain the collision signal due to a fault or a damaged communication link, the third control unit may send the third unlocking instruction to the first control unit, thereby ensuring that the first vehicle door is successfully unlocked.

In an embodiment, the control system further includes a fifth control unit; and the first control unit is further configured to control the first vehicle door to be unlocked when no fourth unlocking instruction from a fifth control unit is received within preset duration since the collision signal is obtained, where the fourth unlocking instruction is used to instruct to unlock the first vehicle door.

Optionally, the fifth control unit and the second control unit may be a same control unit, or may be different control units.

Optionally, the preset duration may be set to 500 milliseconds.

Optionally, the preset duration may be adjusted based on a link distance between the fifth control unit and the first control unit.

For example, when the first control unit is the VIU 1 shown in FIG. 4 and the fifth control unit is the VIU 2 shown in FIG. 4, if the VIU 1 does not receive the fourth unlocking instruction from the VIU 2 within 500 milliseconds since the collision signal is obtained, the first control unit may control the first vehicle door to be unlocked.

For another example, when the first control unit is the VIU 1 shown in FIG. 4 and the fifth control unit is the VIU 3 shown in FIG. 4, if the VIU 1 does not receive the fourth unlocking instruction sent by the VIU 3 within 700 milliseconds since the collision signal is obtained, the first control unit may control the first vehicle door to be unlocked.

In this embodiment of the present disclosure, if the first control unit does not receive the fourth unlocking instruction within the preset duration since the collision signal is obtained, the first control unit may directly control the first vehicle door to be unlocked. In this way, while reducing a case in which the first vehicle door is mistakenly unlocked, reliability of unlocking the first vehicle door can be further improved.

In an embodiment, the first control unit is further configured to control, based on the collision signal, a door handle corresponding to the first vehicle door to pop out. In this way, a vehicle disposed with a hidden door handle facilitates rescue operations by rescue personnel when an accident occurs on the vehicle.

In an embodiment, the first unlocking instruction is further used to instruct to pop out a door handle corresponding to a second vehicle door; and the second control unit is further configured to control, based on the first unlocking instruction, the door handle corresponding to the second vehicle door to pop out. In this way, a vehicle disposed with a hidden door handle facilitates rescue operations by rescue personnel when an accident occurs on the vehicle.

The following describes a control method provided in embodiments of the present disclosure with reference to FIG. 6 to FIG. 10.

FIG. 6 is a control method according to an embodiment of the present disclosure. A method 600 may be applied to the system architecture shown in any one of FIG. 3 to FIG. 5. The method 600 may be performed by a first control unit. The first control unit establishes a communication connection to a second control unit. The method 600 may include steps S601 and S602.
S601: Obtain a collision signal.

Optionally, the first control unit and the second control unit each may be in a form of a chip, a processor, or a controller. Further optionally, the first control unit and the second control unit may be any two vehicle integration units VIUs in any one of the system architectures in FIG. 3 to FIG. 5.

For example, the first control unit may be the VIU 1 in FIG. 3, and the second control unit may be the VIU 2 in FIG. 3. For another example, the first control unit may be the VIU 2 in FIG. 4, and the second control unit may be the VIU 3 in FIG. 4. For still another example, the first control unit may be the VIU 1 in FIG. 5, and the second control unit may be the VIU 3 in FIG. 5.

Optionally, the first control unit may obtain the collision signal from an ABM.
S602: Control, based on the collision signal, a first vehicle door to be unlocked, and send a first unlocking instruction to the second control unit.

The first unlocking instruction is used to unlock a vehicle door corresponding to the second control unit. After receiving the first unlocking instruction, the second control unit may control, based on the first unlocking instruction, a second vehicle door to be unlocked. Further optionally, if the second control unit can obtain the collision signal, the second control unit may control, based on the collision signal and the first unlocking instruction, the second vehicle door to be unlocked.

Optionally, the first control unit is further configured to control, based on the collision signal, a door handle corresponding to the first vehicle door to pop out. In this way, a vehicle disposed with a hidden door handle facilitates rescue operations by rescue personnel when an accident occurs on the vehicle.

Optionally, when the first unlocking instruction is further used to instruct to pop out the door handle corresponding to the second vehicle door, the second control unit may pop out the door handle corresponding to the second vehicle door after receiving the first unlocking instruction. In this way, a vehicle disposed with a hidden door handle facilitates rescue operations by rescue personnel when an accident occurs on the vehicle.

In this embodiment of the present disclosure, the first control unit may unlock the first vehicle door based on the collision signal, and send the first unlocking instruction to the second control unit, so that the second control unit unlocks the second vehicle door based on the first unlocking instruction. In this way, all vehicle doors of a vehicle are not controlled by one control unit to be unlocked. In addition, even if the second control unit cannot obtain the collision signal due to a fault or a damaged communication link, the second control unit can successfully unlock the second vehicle door based on the first unlocking instruction. In this way, it can be ensured that at least one vehicle door is successfully unlocked in a vehicle collision, thereby ensuring personal safety of people inside the vehicle.

In an embodiment, before step S602, if the first control unit has obtained a second unlocking instruction from a third control unit, in step S602, the first control unit may control the first vehicle door to be unlocked based on the second unlocking instruction and the collision signal.

Optionally, the third control unit and the second control unit may be a same control unit, or may be different control units.

For example, when the first control unit is the VIU 2 in FIG. 5, the second control unit is the VIU 1 in FIG. 5, and the third control unit is the VIU 3 in FIG. 5, the second unlocking instruction may be sent by the VIU 3 to the VIU 2 through the VIU 1.

Optionally, the second unlocking instruction may be generated by the third control unit, or may be generated by another control unit and then sent to the third control unit.

For example, when the first control unit is the VIU 2 in FIG. 5 and the third control unit is the VIU 1 in FIG. 5, the second unlocking instruction may be generated by the VIU 1, or may be generated by the VIU 3 and sent to the VIU 1, and then forwarded by the VIU 1 to the VIU 2.

Optionally, after obtaining the collision signal and the second unlocking instruction, the first control unit may control the first vehicle door to be unlocked once, or after obtaining the collision signal, the first control unit may control the first vehicle door to be unlocked once, and then control the first vehicle door to be unlocked once after receiving the second unlocking instruction. In this way, a case in which the first vehicle door is mistakenly unlocked can be reduced, and reliability of unlocking the first vehicle door can be improved, thereby further ensuring personal safety of people inside the vehicle.

In an embodiment, in step S602, the first control unit may control the first vehicle door to be unlocked when no fourth unlocking instruction from a fifth control unit is received within preset duration since the collision signal is obtained, where the fourth unlocking instruction is used to instruct to unlock the first vehicle door. In this way, a case in which the first vehicle door is mistakenly unlocked is reduced, and reliability of unlocking the first vehicle door can be further improved.

Optionally, the fifth control unit and the second control unit may be a same control unit, or may be different control units.

Optionally, the preset duration may be set to 500 milliseconds.

Optionally, the preset duration may be adjusted based on a link distance between the fifth control unit and the first control unit.

For example, when the first control unit is the VIU 1 shown in FIG. 4 and the fifth control unit is the VIU 2 shown in FIG. 4, if the VIU 1 does not receive the fourth unlocking instruction from the VIU 2 within 500 milliseconds since the collision signal is obtained, the first control unit may control the first vehicle door to be unlocked.

For another example, when the first control unit is the VIU 1 shown in FIG. 4 and the fifth control unit is the VIU 3 shown in FIG. 4, if the VIU 1 does not receive the fourth unlocking instruction sent by the VIU 3 within 700 milliseconds since the collision signal is obtained, the first control unit may control the first vehicle door to be unlocked.

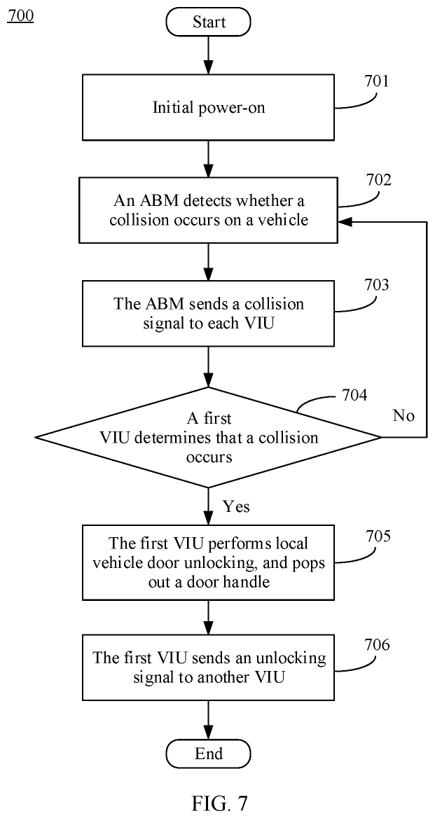

FIG. 7 is another control method according to an embodiment of the present disclosure. A method 700 may be a specific description of the steps of the method 600. The method 700 may be applied to the system architecture shown in FIG. 3. The method 700 may include steps S701 to S706.
S701: Initial power-on.

This step may be understood as powering on controllers (including an ABM and three VIUs) in a vehicle.
S702: The ABM detects whether a collision occurs on the vehicle.

Optionally, the ABM may determine, based on a sensor deployed on a vehicle door, a sensor deployed on a bumper, an acceleration sensor, a deceleration sensor, or a stress sensor, whether a collision occurs on the vehicle.

For example, when an acceleration indicated by the acceleration sensor changes abruptly, the ABM may consider that a collision occurs on the vehicle.

For another example, when a voltage variation of a stress sensor deployed on an A pillar or a B pillar of the vehicle is greater than a preset threshold, the ABM may consider that a collision occurs on the vehicle.
S703: The ABM sends a collision signal to each VIU.

For example, the VIUs may include a VIU 1, a VIU 2, and a VIU 3.
S704: A first VIU determines whether the collision occurs.

For example, the first VIU may be the VIU 1, the VIU 2, or the VIU 3. When the first VIU determines that a collision occurs on the vehicle, step S705 may be performed. When the first VIU determines that no collision occurs on the vehicle, the method 700 may perform step S702 again.

Optionally, the first VIU may determine, based on a sending periodicity of a signal of a CAN bus, whether the collision occurs.

The first VIU may correspond to the first control unit in the method 700.
S705: The first VIU performs local vehicle door unlocking, and pops out a door handle.

For example, when the first VIU is the VIU 1, the VIU 1 may directly drive a right front door lock motor to perform unlocking, and simultaneously drive a hidden door handle motor to pop out a right front door handle. When the first VIU is the VIU 2, the VIU 2 may directly drive a left front door lock motor to perform unlocking, and simultaneously drive a hidden door handle motor to pop out a left front door handle. When the first VIU is the VIU 3, the VIU 3 may directly drive a left rear door lock motor and a right rear door lock motor to perform unlocking, and simultaneously drive hidden door handle motors to pop out a left rear door handle and a right rear door handle.
S706: The first VIU sends an unlocking signal to another VIU.

For example, when the first VIU is the VIU 1, the VIU 1 may send a door lock unlocking request and a door handle popping request to the VIU 2 and the VIU 3. When the first VIU is the VIU 2, the VIU 2 may send a door lock unlocking request and a door handle popping request to the VIU 1 and the VIU 3. When the first VIU is the VIU 3, the VIU 3 may send a door lock unlocking request and a door handle popping request to the VIU 1 and the VIU 2.

It should be understood that in the method 700, the VIUs are distinguished by suffixes 1, 2, and 3. Specifically, positions at which each VIU is connected to a vehicle door may be correspondingly changed. For example, the VIU 1 may be connected to control unlocking of a left front vehicle door, and the VIU 2 may control unlocking of a right front vehicle door.

In this embodiment of the present disclosure, in terms of transmission of the collision signal, the ABM may transmit collision signals to the three VIUs (including the VIU 1, the VIU 2, and the VIU 3) respectively. Even if one or two links between the ABM and the VIUs are damaged due to the collision, the ABM can still transmit the collision signal to at least one VIU through a remaining available link. Then, the VIU that receives the collision signal may transmit the signal to another VIU through the ring network link. In terms of unlocking, different vehicle door motors are connected to different VIUs nearby, and different VIUs can transfer unlocking instructions to each other. When one or two VIUs are damaged due to the collision, successful unlocking of at least one vehicle door can still be ensured, so that a success rate of escape of people inside the vehicle after the vehicle collision can be further improved.

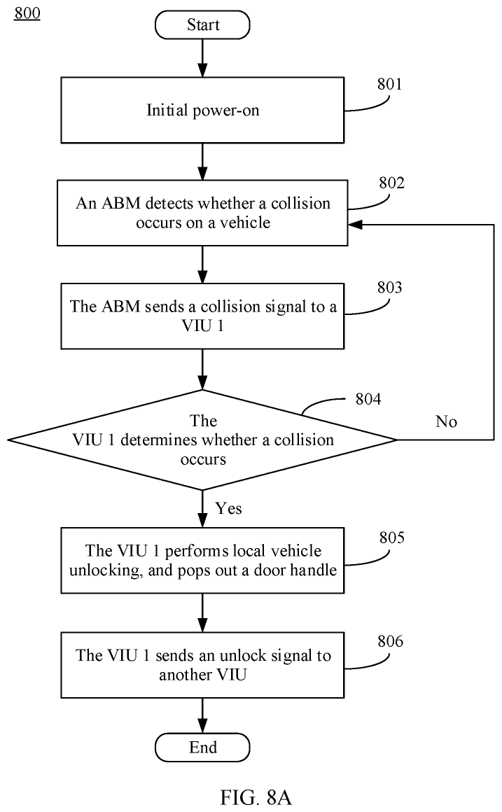

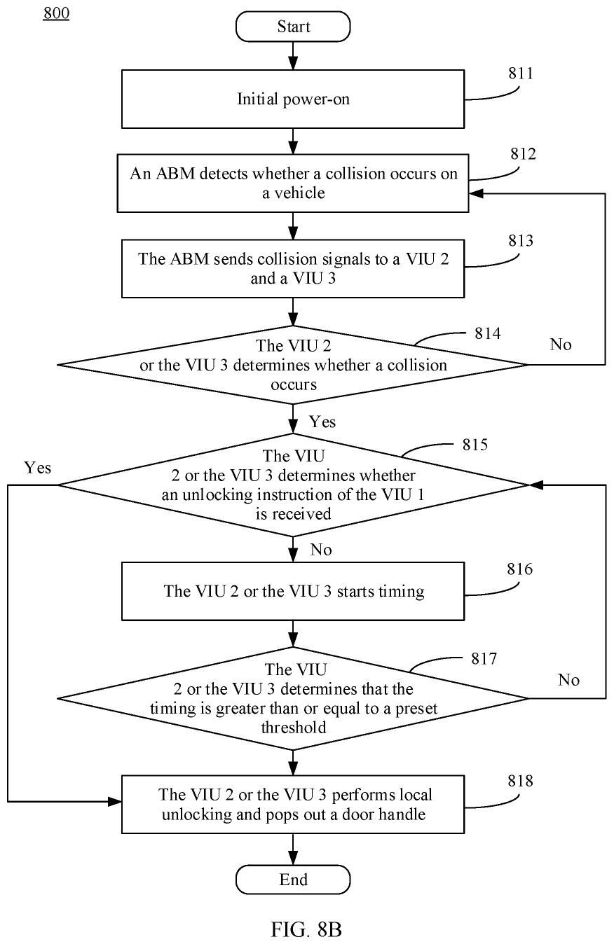

FIG. 8A and FIG. 8B are another control method according to an embodiment of the present disclosure. A method 800 may be a specific description of the steps of the method 600. The method 800 may be applied to the system architecture shown in FIG. 3. The method 800 may include steps S801 to S806 and steps S811 to S818.

In the method 800, the VIU may be divided into a main control module and a secondary module. The following describes the method 800 by using an example in which a VIU 1 is a main control module, and a VIU 2 and a VIU 3 are secondary modules.

FIG. 8A is a schematic flowchart of interaction between an ABM and the VIU 1.
S801: Initial power-on.

This step may be understood as powering on the ABM and the VIU 1 in a vehicle.
S802: The ABM detects whether a collision occurs on the vehicle.

Optionally, the ABM may determine, based on a sensor deployed on a vehicle door, a sensor deployed on a bumper, an acceleration sensor, a deceleration sensor, or a stress sensor, whether a collision occurs on the vehicle.

For example, when an acceleration indicated by the acceleration sensor changes abruptly, the ABM may consider that a collision occurs on the vehicle.

For another example, when a voltage variation of a stress sensor deployed on an A pillar or a B pillar of the vehicle is greater than a preset threshold, the ABM may consider that a collision occurs on the vehicle.
S803: The ABM sends a collision signal to the VIU 1.
S804: The VIU 1 determines whether the collision occurs.

For example, when the VIU 1 determines that a collision occurs on the vehicle, step S805 may be performed, and when the VIU 1 determines that no collision occurs on the vehicle, the method 800 may perform step S803 again.

Optionally, the VIU 1 may determine, based on a sending periodicity of a signal of a CAN bus, whether the collision occurs.
S805: The VIU 1 performs local vehicle door unlocking, and pops out a door handle.

For example, the VIU 1 may directly drive a right front door lock motor to perform unlocking, and simultaneously drive a hidden door handle motor to pop out a right front door handle.
S806: The VIU 1 sends an unlocking signal to another VIU.

For example, the VIU 1 may send a door lock unlocking request and a door handle popping request to the VIU 2 and the VIU 3.

FIG. 8B is a schematic flowchart of interaction between the ABM and the VIU 1 and interaction between the ABM and the VIU 2 or the VIU 3.
S811: Initial power-on.

This step may be understood as powering on the VIU 2 and the VIU 3 in the vehicle.
S812: The ABM detects whether a collision occurs on the vehicle.

For example, the step of detecting, by the ABM, whether a collision occurs on the vehicle may be the same as step S802.
S813: The ABM sends collision signals to the VIU 2 and the VIU 3.
S814: The VIU 2 or the VIU 3 determines whether the collision occurs.

For example, when the VIU 2 or the VIU 3 determines that a collision occurs on the vehicle, step S815 may be performed. When the VIU 2 or the VIU 3 determines that no collision occurs on the vehicle, step S812 is performed again.

Optionally, the VIU 2 and the VIU 3 may determine, based on a sending periodicity of a signal of a CAN bus, whether the collision occurs.
S815: The VIU 2 or the VIU 3 determines whether an unlocking instruction of the VIU 1 is received.

For example, after the VIU 2 or the VIU 3 receives the unlocking instruction of the VIU 1, the VIU 2 or the VIU 3 may perform step S818, or the VIU 2 or the VIU 3 performs step S816.
S816: The VIU 2 or the VIU 3 starts timing.
S817: The VIU 2 or the VIU 3 determines whether the timing is greater than or equal to a preset threshold.

For example, when the timing is greater than or equal to the preset threshold, and the VIU 2 or the VIU 3 still does not receive an unlock request, the VIU 2 or the VIU 3 may perform step S818. Otherwise, step S815 may be performed again.

Optionally, the preset threshold may be 500 milliseconds.
S818: The VIU 2 or the VIU 3 performs local unlocking and pops out a door handle.

For example, the VIU 2 may directly drive a left front door lock motor to perform unlocking and pop out a left front door handle, and the VIU 3 may drive a left rear door lock motor and a right rear door lock motor to perform unlocking and pop out a left rear door handle and a right rear door handle.

It should be understood that in the method 800, that the VIU 1 is a main control module, and the VIU 2 and the VIU 3 are secondary modules is merely an example for description. In some possible implementations, the VIU 2 may be a main control module, and the VIU 1 and the VIU 3 may be secondary modules. Alternatively, the VIU 3 may be a main control module, and the VIU 1 and the VIU 2 may be secondary modules.

In this embodiment of the present disclosure, VIUs are classified into a main control module and secondary modules. After detecting a collision signal, the VIU serving as the secondary module first detects whether an unlocking instruction sent by the main control module VIU exists. If timing times out, the VIU serving as the secondary module may directly unlock a corresponding vehicle door based on a collision signal. In this way, a case in which the first vehicle door is mistakenly unlocked is reduced, and reliability of unlocking the first vehicle door can be further improved.

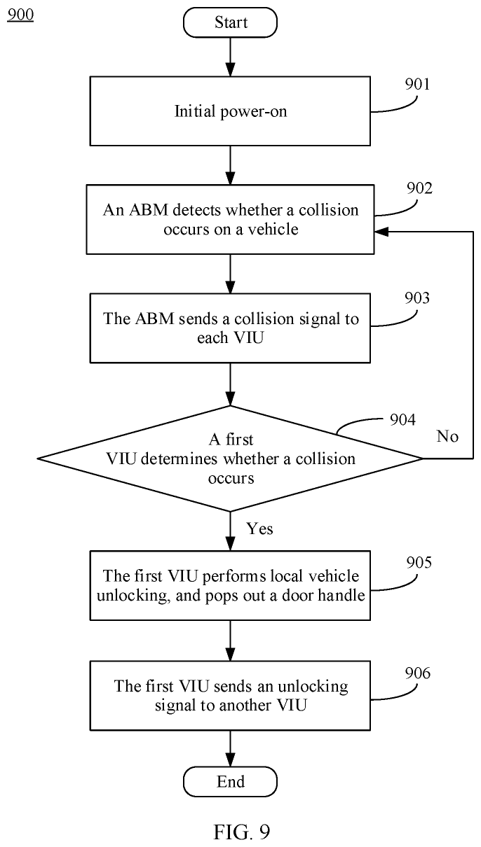

FIG. 9 is another control method according to an embodiment of the present disclosure. A method 900 may be a specific description of the steps of the method 600. The method 900 may be applied to the system architecture shown in FIG. 4. The method 900 may include steps S901 to S906.
S901: Initial power-on.

This step may be understood as powering on a VIU 1 to a VIU 4 in a vehicle.
S902: An ABM detects whether a collision occurs on the vehicle.

Optionally, the ABM may determine, based on a sensor deployed on a vehicle door, a sensor deployed on a bumper, an acceleration sensor, a deceleration sensor, or a stress sensor, whether a collision occurs on the vehicle.

For example, when an acceleration indicated by the acceleration sensor changes abruptly, the ABM may consider that a collision occurs on the vehicle.

For another example, when a voltage variation of a stress sensor deployed on an A pillar or a B pillar of the vehicle is greater than a preset threshold, the ABM may consider that a collision occurs on the vehicle.
S903: The ABM sends a collision signal to each VIU.

For example, the VIU may include the VIU 1 to the VIU 4.
S904: A first VIU determines whether the collision occurs.

For example, the first VIU may be any one of the VIU 1 to the VIU 4. When the first VIU determines that a collision occurs on the vehicle, step S905 may be performed. When the first VIU determines that no collision occurs on the vehicle, the method 900 may perform step S902 again.

The first VIU may correspond to the first control unit in the method 600.

Optionally, the first VIU may determine, based on a sending periodicity of a signal of a CAN bus, whether the collision occurs.
S905: The first VIU performs local vehicle door unlocking, and pops out a door handle.

For example, when the first VIU is the VIU 1, the VIU 1 may directly drive a right front door lock motor to perform unlocking, and simultaneously drive a hidden door handle motor to pop out a right front door handle. When the first VIU is the VIU 2, the VIU 2 may directly drive a left front door lock motor to perform unlocking, and simultaneously drive a hidden door handle motor to pop out a left front door handle. When the first VIU is the VIU 3, the VIU 3 may directly drive a left rear door lock motor to perform unlocking, and simultaneously drive a hidden door handle motor to pop out a rear left door handle. When the first VIU is the VIU 4, the VIU 4 may directly drive a right rear door lock motor to perform unlocking, and simultaneously drive a hidden door handle motor to pop out a right rear door handle.
S906: The first VIU sends an unlocking signal to another VIU.

For example, when the first VIU is the VIU 1, the VIU 1 may send a door lock unlocking request and a door handle popping request to the VIU 2, the VIU 3, and the VIU 4. When the first VIU is the VIU 2, the VIU 2 may send a door lock unlocking request and a door handle popping request to the VIU 1, the VIU 3, and the VIU 4. When the first VIU is the VIU 3, the VIU 3 may send a door lock unlocking request and a door handle popping request to the VIU 1, the VIU 2, and the VIU 4. When the first VIU is the VIU 4, the VIU 4 may send a door lock unlocking request and a door handle popping request to the VIU 1, the VIU 2, and the VIU 3.

It should be understood that, in the method 900, the VIUs are distinguished by suffixes 1, 2, 3, and 4. Specifically, positions at which each VIU is connected to a vehicle door may be correspondingly changed.

In this embodiment of the present disclosure, different vehicle door motors are connected to different VIUs nearby, and different VIUs can transfer unlocking instructions to each other. When one or two VIUs are damaged due to the collision, successful unlocking of at least one vehicle door can still be ensured. The method 900 increases a quantity of VIUs, and each door lock motor is controlled by one VIU, so that a success rate of escape of people inside the vehicle after the vehicle collision can be further improved.

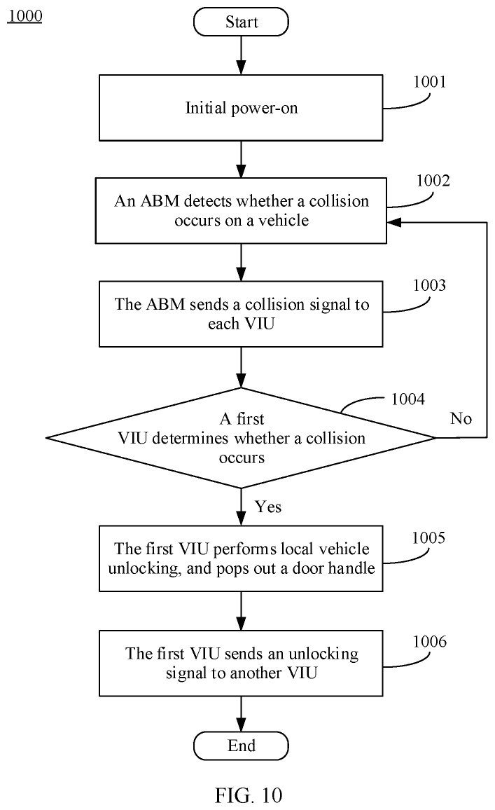

FIG. 10 is another control method according to an embodiment of the present disclosure. A method 1000 may be a specific description of the steps of the method 600. The method 1000 may be applied to the system architecture shown in FIG. 5. The method 1000 may include steps S1001 to S1006.
S1001: Initial power-on.

This step may be understood as powering on controllers (including an ABM and three VIUs) in a vehicle.
S1002: The ABM detects whether a collision occurs on the vehicle.

Optionally, the ABM may determine, based on a sensor deployed on a vehicle door, a sensor deployed on a bumper, an acceleration sensor, a deceleration sensor, or a stress sensor, whether a collision occurs on the vehicle.

For example, when an acceleration indicated by the acceleration sensor changes abruptly, the ABM may consider that a collision occurs on the vehicle.

For another example, when a voltage variation of a stress sensor deployed on an A pillar or a B pillar of the vehicle is greater than a preset threshold, the ABM may consider that a collision occurs on the vehicle.
S1003: The ABM sends a collision signal to each VIU.

For example, the VIUs may include a VIU 1, a VIU 2, and a VIU 3.
S1004: A first VIU determines whether the collision occurs.

For example, the first VIU may be the VIU 1, the VIU 2, or the VIU 3. When the first VIU determines that a collision occurs on the vehicle, step S1005 may be performed. When the first VIU determines that no collision occurs on the vehicle, the method 1000 may perform step S1002 again.

Optionally, the first VIU may determine, based on a sending periodicity of a signal of a CAN bus, whether the collision occurs.

The first VIU may correspond to the first control unit in the method 600.
S1005: The first VIU performs local vehicle door unlocking, and pops out a door handle.

For example, when the first VIU is the VIU 1, the VIU 1 may directly drive a right front door lock motor to perform unlocking, and simultaneously drive a hidden door handle motor to pop out a right front door handle. When the first VIU is the VIU 2, the VIU 2 may directly drive a left front door lock motor to perform unlocking, and simultaneously drive a hidden door handle motor to pop out a left front door handle. When the first VIU is the VIU 3, the VIU 3 may directly drive a left rear door lock motor and a right rear door lock motor to perform unlocking, and simultaneously drive hidden door handle motors to pop out a left rear door handle and a right rear door handle.
S1006: The first VIU sends an unlocking signal to another VIU.

For example, when the first VIU is the VIU 1, the VIU 1 may send a door lock unlocking request and a door handle popping request to the VIU 2 and the VIU 3. When the first VIU is the VIU 2, the VIU 2 may send a door lock unlocking request and a door handle popping request to the VIU 1, and the VIU 1 may forward the requests to the VIU 3 after receiving the unlocking request and the door handle popping request. When the first VIU is the VIU 3, the VIU 3 may send a door lock unlocking request and a door handle popping request to the VIU 1, and the VIU 1 may forward the requests to the VIU 2 after receiving the unlocking request and the door handle popping request.

It should be understood that in the method 1000, the VIUs are distinguished by suffixes 1, 2, and 3. Specifically, positions at which each VIU is connected to a vehicle door may be correspondingly changed.

In this embodiment of the present disclosure, different vehicle door motors are connected to different VIUs nearby, and different VIUs can transfer unlocking instructions to each other. This can improve a success rate of escape of people inside the vehicle after the vehicle collision.

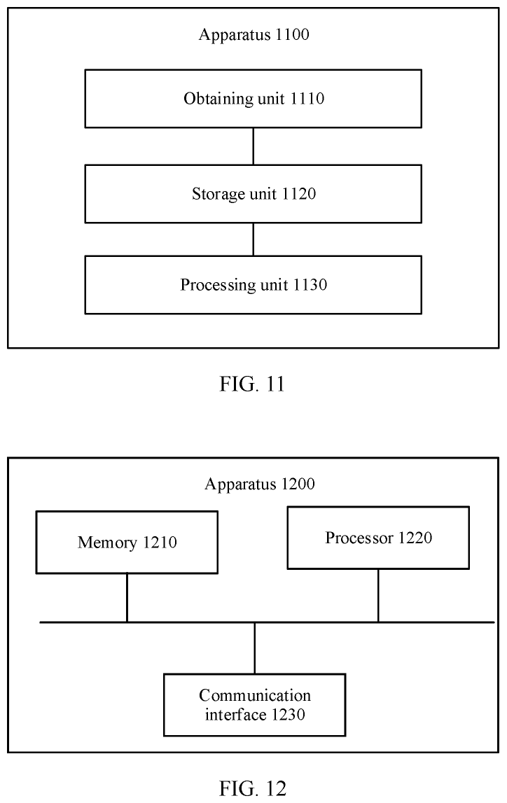

FIG. 11 is a diagram of a control apparatus 1100 according to an embodiment of the present disclosure. The apparatus 1100 may include an obtaining unit 1110, a storage unit 1120, and a processing unit 1130. The obtaining unit 1110 is configured to obtain instructions and/or data. The storage unit 1120 is configured to implement a corresponding storage function and store corresponding instructions and/or data. The processing unit 1130 is configured to perform data processing, so that the apparatus 1100 implements the foregoing control method.

The apparatus 1100 includes: the obtaining unit 1110 and the processing unit 1130. The obtaining unit 1110 is configured to obtain a collision signal. The processing unit 1130 is configured to: control, based on the collision signal, a first vehicle door to be unlocked, and send a first unlocking instruction to a second control unit. The first unlocking instruction is used to instruct to unlock a second vehicle door corresponding to the second control unit.

In a possible implementation, the obtaining unit 1110 is further configured to obtain a second unlocking instruction from a third control unit. The second unlocking instruction is used to instruct to unlock the first vehicle door. The processing unit 1130 is specifically configured to control, based on the collision signal and the second unlocking instruction, the first vehicle door to be unlocked.

In a possible implementation, the processing unit 1130 is specifically configured to control the first vehicle door to be unlocked when no fourth unlocking instruction from a fifth control unit is received within preset duration since the collision signal is obtained, where the fourth unlocking instruction is used to instruct to unlock the first vehicle door.

In a possible implementation, the processing unit 1130 is further configured to control, based on the collision signal, a door handle corresponding to the first vehicle door to pop out.

In a possible implementation, the first unlocking instruction is further used to instruct to pop out a door handle corresponding to the second vehicle door.

Optionally, if the apparatus 1100 is located in the vehicle 100, the processing unit 1130 may be the processor 131 shown in FIG. 1.

FIG. 12 is a diagram of another control apparatus 1200 according to an embodiment of the present disclosure.

The apparatus 1200 includes a memory 1210, a processor 1220, and a communication interface 1230. The memory 1210, the processor 1220, and the communication interface 1230 are connected through an internal connection path. The memory 1210 is configured to store instructions. The processor 1220 is configured to execute the instructions stored in the memory 1210, to control the communication interface 1230 to obtain information, so that the apparatus 1200 implements the foregoing control method. Optionally, the memory 1210 may be coupled to the processor 1220 through the interface, or may be integrated together with the processor 1220.

It should be noted that the communication interface 1230 uses a transceiver apparatus such as but not limited to a transceiver. The communication interface 1230 may further include an input/output interface.

The processor 1220 stores one or more computer programs, and the one or more computer programs include instructions. When the instructions are run by the processor 1220, the control apparatus 1200 is enabled to perform the control methods in the foregoing embodiments.

In an implementation process, steps of the foregoing methods can be implemented by using a hardware integrated logic circuit in the processor 1220, or by using instructions in a form of software. The method of the communication disclosed with reference to embodiments of the present disclosure may be directly performed by a hardware processor, or may be performed by using a combination of hardware in the processor and a software module. A software module may be located in a mature storage medium in the art, such as a random-access memory (RAM), a flash memory, a read-only memory (ROM), a programmable ROM, an electrically erasable programmable memory, or a register. The storage medium is located in the memory 1210. The processor 1220 reads information from the memory 1210, and performs the steps of the foregoing method in combination with hardware of the processor. To avoid repetition, details are not described herein again.

Optionally, the communication interface 1230 in FIG. 12 may implement the obtaining unit 1110 in FIG. 11, the memory 1210 in FIG. 12 may implement the storage unit 1120 in FIG. 11, and the processor 1220 in FIG. 12 may implement the processing unit 1130 in FIG. 11.

Optionally, the apparatus 1100 or the apparatus 1200 may be located in the vehicle 100 in FIG. 1.

Optionally, the apparatus 1100 or the apparatus 1200 may be the computing platform 130 in the vehicle in FIG. 1.

An embodiment of the present disclosure further provides a computer-readable storage medium. The computer-readable storage medium stores program code. When the computer program code is run on a computer, the computer is enabled to perform any one of the methods in FIG. 6 to FIG. 10.

An embodiment of the present disclosure further provides a computer program product. The computer product includes a computer program. When the computer program is run, a computer is enabled to perform any one of the methods in FIG. 6 to FIG. 10.

Embodiments of the present disclosure further provide a chip, including a circuit. The circuit is configured to perform any one of the methods in FIG. 6 to FIG. 10.

Embodiments of the present disclosure further provide a vehicle, including any control apparatus shown in FIG. 11 or FIG. 12.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, refer to a corresponding procedure in the foregoing method embodiments.

In the several embodiments provided in the present disclosure, it should be understood that the disclosed system, apparatus, and method may be implemented in other manners. For example, the described apparatus embodiments are merely examples. For example, division into the units is merely logical function division. There may be another division manner during actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of the present disclosure may be integrated into one processing unit, each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of the present disclosure may be implemented in a form of a software product. The computer software product is stored in a storage medium, and includes several instructions for instructing a computer device (which may be a personal computer, a server, a network device, or the like) to perform all or some of the steps of the methods described in embodiments of the present disclosure. The foregoing storage medium includes any medium that can store program code, such as a Universal Serial Bus (USB) flash drive, a removable hard disk, a ROM, a RAM, a magnetic disk, or an optical disc.

The foregoing descriptions are merely specific implementations of the present disclosure, but are not intended to limit the protection scope of this application. Any variation or replacement readily figured out by a person skilled in the art within the technical scope disclosed in the present disclosure shall fall within the protection scope of this application. Therefore, the protection scope of this application shall be subject to the protection scope of the claims.

What is claimed is:

1. A control system; comprising:
a second controller configured to control a second vehicle door to be unlocked; and
a first controller configured to:
establish a communication connection to the second controller:
obtain a collision signal;
control, based on the collision signal, a first vehicle door to be unlocked; and
send a first unlocking instruction to the second controller;
wherein the first unlocking instruction instructs the second controller to unlock the second vehicle door.

2. The system of claim 1, further comprising a third controller configured to send a second unlocking instruction to the first controller, wherein the second unlocking instruction instructs the first controller to unlock the first vehicle door, and wherein the first controller is further configured to further control, based on the collision signal and the second unlocking instruction, the first vehicle door to be unlocked.

3. The system accord of claim 1, further comprising:
a third controller; and
a fourth controller configured to:
obtain the collision signal;
generate a third unlocking instruction based on the collision signal, wherein the third unlocking instruction instructs to unlock the first vehicle door; and
send the third unlocking instruction to the third controller;
wherein the third controller is further configured to send the third unlocking instruction to the first controller; and
wherein the first controller is further configured to further control, based on the third unlocking instruction, the first vehicle door to be unlocked.

4. The system of claim 1, further comprising a fifth controller configured to send a fourth unlocking instruction to the first controller, wherein the fourth unlocking instruction instructs the first controller to unlock the first vehicle door, and wherein the controller is further configured to further control the first vehicle door to be unlocked when not receiving the fourth unlocking instruction within preset duration since obtaining the collision signal.

5. The system claim 1, wherein the first controller is further configured to control, based on the collision signal, a door handle corresponding to the first vehicle door to pop out.

6. The system of claim 1, wherein the second controller is further configured to further control, based on the first unlocking instruction, the second vehicle door to be unlocked.

7. The system of claim 1, wherein the second controller is further configured to:
obtain the collision signal; and
further control, based on the collision signal and the first unlocking instruction, the second vehicle door to be unlocked.

8. The system of claim 1, wherein the first unlocking instruction further instructs the second controller to pop out a door handle corresponding to the second vehicle door, and wherein the second controller is further configured to control, based on the first unlocking instruction, the door handle pop out.

9. A method, implemented by a first controller, the method comprising:
obtaining a collision signal;
controlling, based on the collision signal, a first vehicle door to be unlocked; and
sending a first unlocking instruction to a second controller,
wherein the first unlocking instruction instructs the second controller to unlock a second vehicle door corresponding to the second controller.

10. The method of claim 9, further comprising obtaining a second unlocking instruction from a third controller, wherein the second unlocking instruction instructs the first controller to unlock the first vehicle door, and wherein controlling, based on the collision signal, the first vehicle door to be unlocked comprises controlling, based on the collision signal and the second unlocking instruction, the first vehicle door to be unlocked.

11. The method of claim 10, wherein controlling, based on the collision signal, the first vehicle door to be unlocked comprises controlling the first vehicle door to be unlocked when we not receiving a fourth unlocking instruction from a fifth controller within preset duration since obtaining the collision signal is obtained, and wherein the fourth unlocking instruction instructs the first controller to unlock the first vehicle door.

12. The method of claim 9, further comprising controlling, based on the collision signal, a door handle corresponding to the first vehicle door to pop out.

13. The method of claim 9, wherein the first unlocking instruction further instructs the second controller to pop out a door handle corresponding to the second vehicle door.

14. A first controller comprising:
a memory configured to store instructions; and
one or more processors coupled to the memory and configured to execute the instructions to cause the first controller to:
obtain a collision signal;
control, based on the collision signal, a first vehicle door to be unlocked; and
send a first unlocking instruction to a second controller,
wherein the first unlocking instruction instructs the second controller to unlock a second vehicle door corresponding to the second controller.

15. The first controller of claim 14, wherein the one or more processors are further configured to execute the instructions to cause the first controller to:
obtain a second unlocking instruction from a third controller, wherein the second unlocking instruction instructs the first controller to unlock the first vehicle door; and
further control, based on the collision signal and the second unlocking instruction, the first vehicle door to be unlocked.

16. The first controller of claim 14, wherein the one or more processors are further configured to execute the instructions to cause the first controller to further control the first vehicle door to be unlocked when not receiving a fourth unlocking instruction from a third controller is within a preset duration since obtaining the collision signal, and wherein the fourth unlocking instruction instructs the first controller to unlock the first vehicle door.

17. The first controller of claim 14, wherein the one or more processors are further configured to execute the instructions to cause the first controller to control, based on the collision signal, a door handle corresponding to the first vehicle door to pop out.

18. The first controller of claim 14, wherein the first unlocking instruction further instructs the second controller to pop out a door handle corresponding to the second vehicle door.

19. The first controller of claim 14, wherein the first controller is further configured to execute the instructions to cause the first controller to connect to the second controller via a network link forming a ring network configured for bidirectional signal transmission.

20. The first controller of claim 16, wherein the first controller is further configured to execute the instructions to cause the first controller to adjust the preset duration based on a distance of a communication link between the first controller and the third controller.
